(19) United States
(12) Patent Application Publication
(10) Pub. No.: US 2018/0241293 A1
(43) Pub. Date: Aug. 23, 2018

(54) VIBRATION MOTOR

(71) Applicant: Nidec Seimitsu Corporation, Ueda-shi (JP)

(72) Inventor: Masahiko MIYAZAKI, Ueda-shi (JP)

(21) Appl. No.: 15/899,541

(22) Filed: Feb. 20, 2018

(30) Foreign Application Priority Data
Feb. 22, 2017 (JP) 2017-031302

(51) Int. Cl. H02K 33/16; H02K 33/02; B06B 1/04

(52) U.S. Cl. CPC H02K 33/16; B06B 1/045; H02K 33/02

(57) ABSTRACT

A vibration motor includes a stationary portion, a vibrating body supported to vibrate in a lateral direction with respect to the stationary portion, and an elastic member positioned between the stationary portion and the vibrating body. The elastic member includes two or more first bent portions bent in a longitudinal direction orthogonal to the lateral direction, one or more second bent portions bent toward a side opposite to the first bent portion in the longitudinal direction, and flat portions connected to ends of the first bent portions and the second bent portions. The number of first bent portions is greater than that of second bent portions, the first bent portions and the second bent portions are alternately connected by the flat portions, and the maximum width of the first bent portions in the lateral direction is smaller than the minimum width of the second bent portions in the lateral direction.

### CROSS REFERENCE TO RELATED APPLICATIONS

This application claims the benefit of priority to Japanese Patent Application No. 2017-031302 filed on Feb. 22, 2017. The entire contents of this application are hereby incorporated herein by reference.

### BACKGROUND OF THE INVENTION

### 1. Field of the Invention

The present invention relates to a vibration motor.

### 2. Description of the Related Art

In the related art, various devices such as a smartphone and the like are provided with a vibration motor. Examples of the vibration motor include a lateral linear vibration motor in which a vibrating body vibrates in the lateral direction. An example of such a vibration motor of the related art is disclosed in Chinese Patent Application Publication No. 105518983.

The vibration motor in Chinese Patent Application Publication No. 105518983 has a cover, a base plate, a coil member, a vibrating body that vibrates in the lateral direction, and a pair of elastic members. The coil member is fixed on the base plate. The coil member is accommodated in an internal space of the vibrating body.

One end of one of the elastic members is fixed to one end portion of the vibrating body in the lateral direction. The other end of the one of the elastic members is fixed to an inner surface of the cover. One end of the other of the elastic members is fixed to the other end portion of the vibrating body in the lateral direction. The other end of the other of the elastic members is fixed to the inner surface of the cover.

The pair of elastic members described above is a leaf spring member and includes a plurality of bent portions and a flat portion that connects the bent portions in order.

In Chinese Patent Application Publication No. 105518983 described above, the elastic member has three bent portions that are bent toward one side in a longitudinal direction orthogonal to the lateral direction and two bent portions that are bent toward the other side in the longitudinal direction. Intervals between adjacent flat portions in the lateral direction are uniform.

With such a configuration, when one of the elastic members is compressed by the displacement of the vibrating body, there is a concern that the three bent portions that are bent toward one side in the longitudinal direction, the number of which is greater than the two bent portions that are bent toward the other side in the longitudinal direction, are more likely to collide with each other. When the bent portions collide with each other, there is a problem that noise due to a collision sound is generated.

### SUMMARY OF THE INVENTION

In one exemplary embodiment of the present invention, a vibration motor includes a stationary portion, a vibrating body that is supported to vibrate in a lateral direction with respect to the stationary portion, and an elastic member that is positioned between the stationary portion and the vibrating body. The elastic member includes two or more first bent portions that are bent in a longitudinal direction orthogonal to the lateral direction, one or more second bent portions that are bent toward a side opposite to the first bent portion in the longitudinal direction, and flat portions that are connected to respective ends of the first bent portions and respective ends of the second bent portions. The number of first bent portions is greater than the number of second bent portions, the first bent portions and the second bent portions are alternately connected by the flat portions, and a maximum width of the first bent portions in the lateral direction is smaller than a minimum width of the second bent portions in the lateral direction.

According to an exemplary embodiment of the present application, the vibration motor can suppress generation of noise due to the elastic member.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an overall perspective view as viewed from above illustrating a vibration motor according to a first embodiment of the present invention.

FIG. 2 is a plan sectional view illustrating the vibration motor according to the first embodiment of the present invention (in a stationary state).

FIG. 3 is a plan sectional view illustrating the vibration motor according to the first embodiment of the present invention (at the time of maximum displacement).

FIG. 4 is a plan view illustrating an elastic member according to a comparative example.

FIG. 5 is a plan view illustrating an elastic member according to an embodiment of the present invention.

FIG. 6 is a partial plan sectional view illustrating a case if the elastic member according to the comparative example was applied to the vibration motor.

FIG. 7 is a plan view illustrating an elastic member according to a modification example of the present invention.

FIG. 8 is a plan view illustrating an elastic member according to another modification example of the present invention.

FIG. 9 is a plan sectional view illustrating a vibration motor according to a second embodiment of the present invention.

FIG. 10 is a plan sectional view illustrating a vibration motor according to a third embodiment of the present invention.

### DETAILED DESCRIPTION OF THE PREFERRED EMBODIMENTS

Exemplary embodiments of the present invention will be described below with reference to the drawings. In the following drawings, X-direction represents a lateral direction which is the direction in which the vibrating body vibrates. Specifically, one side in the lateral direction is represented by the X1-direction and the other side in the lateral direction is represented by the X2-direction. In addition, Y-direction represents a longitudinal direction which is a direction orthogonal to the lateral direction. Specifically, one side in the longitudinal direction is represented by the Y1-direction and the other side in the longitudinal direction is expressed as the Y2-direction. In addition, Z-direction represents the up and down direction which is a direction orthogonal to the lateral direction and the longitudinal direction. Specifically, the upper side is represented by the Z1-direction, and the lower side is represented by the Z2-direction. However, the definition of these directions do not indicate the positional relationships and directions when the vibrating body is incorporated in an actual device.

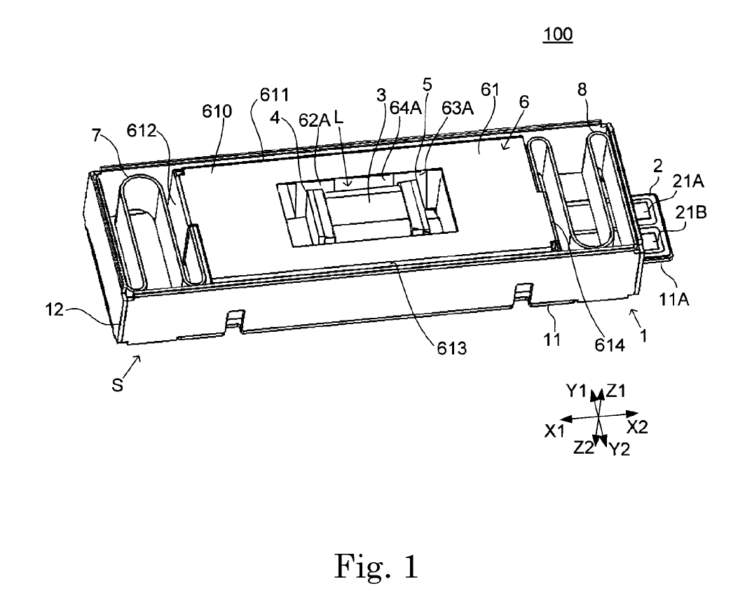

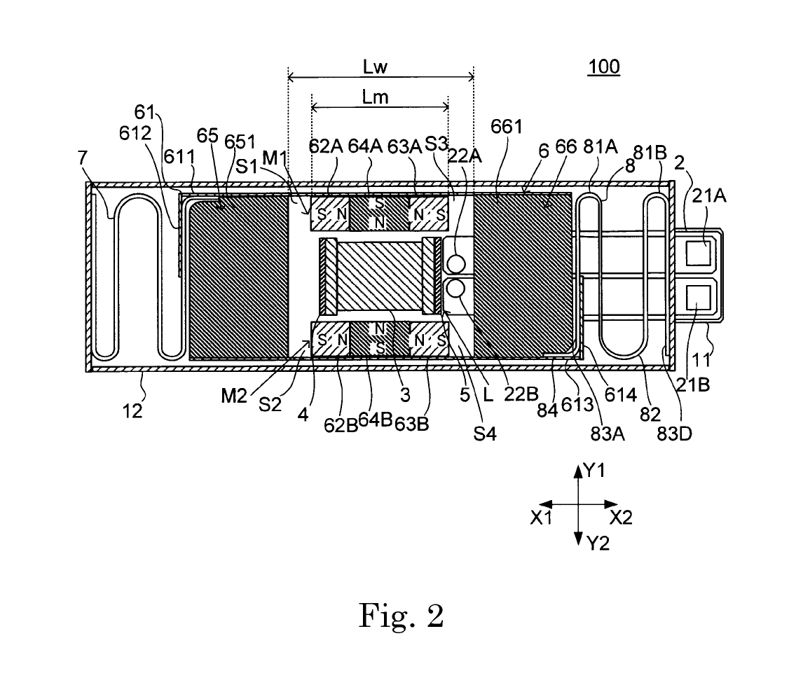

FIG. 1 is an overall perspective view as viewed from above illustrating a vibration motor 100 according to a first embodiment of the present invention. However, in FIG. 1, the illustration of the top surface portion of a cover 12 is omitted, and thus the inside portion of the cover 12 is visible, and in an actual product, the inside configuration cannot be seen due to the top surface portion of the cover 12. FIG. 2 is a plan sectional view in a top view in a state where the vibration motor 100 is cut at a position in the middle of the up and down direction of the cover 12.

The vibration motor 100 includes, roughly speaking, a stationary portion S, a vibrating body 6, and a pair of elastic members 7 and 8. The stationary portion S includes a casing 1, a substrate 2, and a coil portion L.

The casing 1 includes a base plate 11 and a cover 12. The base plate 11 is a plate-like member extending in the lateral direction and has a protruding base portion 11A at the other end portion in the lateral direction. The cover 12 has a top surface portion (not illustrated) and side surface portions extending downward from four sides of the top surface portion, respectively. The cover 12 is attached to the base plate 11 from above. The casing 1 accommodates a substrate 2, a coil portion L, the vibrating body 6, and elastic members 7 and 8 therein.

The substrate 2 is fixed to an upper surface of the base plate 11 and is formed of a flexible printed circuit board (FPC). The substrate 2 may be a rigid substrate. The substrate 2 extends in the lateral direction and the other end portion thereof in the lateral direction is disposed on a protruding base portion 11A. Terminals 21A and 21B are provided on the other end portion of the substrate 2.

The coil portion L includes a coil member 3 and damper members 4 and 5. The coil member 3 is formed by winding a coil wire around a shaft extending in the lateral direction. An iron core extending in the lateral direction is disposed in a space surrounded by the coil wire. With this iron core, a magnetic flux density in the space surrounded by the coil wire can be increased. The coil member 3 is fixed to the upper surface of the base plate 11. Lead wires led out from the coil member 3 are electrically connected to terminals 22A and 22B of the substrate 2. The terminal 21A and the terminal 22A are electrically connected to each other and the terminal 21B and the terminal 22B are electrically connected to each other. Accordingly, by applying a voltage from outside of the vibration motor 100 to the terminals 21A and 21B, a current flows to the coil member 3 and the coil member 3 can be driven. By controlling the current flowing through the coil member 3, the coil member 3 switches between a state of generating an N-pole in one side in the lateral direction and an S-pole in the other side in the lateral direction and a state of generating the S-pole in one side in the lateral direction and the N-pole in the other side in the lateral direction. In other words, the coil member 3 generates magnetic flux in the lateral direction.

A damper member 4 is fixed to one end portion of the coil member 3 in the lateral direction and a damper member 5 is fixed to the other end portion of the coil member 3 in the lateral direction.

The vibrating body 6 includes a holding portion 61, a first magnet portion M1, a second magnet portion M2, a first weight portion 65, and a second weight portion 66. The holding portion 61 has a top plate portion 610 and side plate portions 611 to 614 which protrude downward from the four sides of the top plate portion 610, respectively. The side plate portion 611 and the side plate portion 613 which extend in the lateral direction are opposed each other in the longitudinal direction. The side plate portion 612 extending in the longitudinal direction is connected to one end portion of the side plate portion 611 in the lateral direction. The side plate portion 614 extending in the longitudinal direction is connected to the other end portion of the side plate portion 613 in the lateral direction.

The first magnet portion M1 is fixed to an inner surface of the side plate portion 611. The second magnet portion M2 is fixed to the inner surface of the side plate portion 613. The first weight portion 65 and the second weight portion 66 are fixed to the inner surface of the side plate portion 611 and the inner surface of the side plate portion 613, respectively. Accordingly, the first magnet portion M1, the second magnet portion M2, the first weight portion 65, and the second weight portion 66 are held by the holding portion 61.

The first magnet portion M1 includes a first magnet 62A, a second magnet 63A, and a third magnet 64A. The third magnet portion 64A is disposed to be interposed between the first magnet 62A and the second magnet 63A from both sides in the lateral direction.

The first magnet 62A has an S-pole on one side in the lateral direction and an N-pole on the other side in the lateral direction. The second magnet 63A has an N-pole on one side in the lateral direction and an S-pole on the other side in the lateral direction. In other words, the first magnet 62A and the second magnet 63A have magnetic flux directions opposite to each other in the lateral direction.

The third magnet 64A has an S-pole on one side in the longitudinal direction and an N-pole on the other side in the longitudinal direction. In other words, the third magnet 64A has a magnetic flux direction in the longitudinal direction.

The first magnet portion M1 and the coil portion L are disposed to face each other in the longitudinal direction. A so-called Halbach array structure is configured by the magnetic poles being disposed in the first magnet portion M1 as described above. Accordingly, a magnetic path for concentrating the magnetic flux toward the coil portion L can be formed.

The second magnet portion M2 is disposed to oppose the first magnet portion M1 in the longitudinal direction with the coil portion L interposed therebetween and includes a first magnet 62B, a second magnet 63B, and a third magnet 64B. The third magnet portion 64B is disposed to be interposed between the first magnet 62B and the second magnet 63B from both sides in the lateral direction.

The first magnet 62B has an S-pole on one side in the lateral direction and an N-pole on the other side in the lateral direction. The second magnet 63B has an N-pole on one side in the lateral direction and an S-pole on the other side in the lateral direction. In other words, the first magnet 62B and the second magnet 63B have magnetic flux directions opposite to each other in the lateral direction.

The third magnet 64B has an N-pole on one side in the longitudinal direction and an S-pole on the other side in the longitudinal direction. In other words, the third magnet 64B has a magnetic flux direction in the longitudinal direction.

The second magnet portion M2 and the coil portion L are disposed to face each other in the longitudinal direction. By disposing the magnetic poles in the second magnet portion M2 as described above, the Halbach array structure is configured. Accordingly, a magnetic path for concentrating the magnetic flux toward the coil portion L can be formed.

Only one of the first magnet portion M1 and the second magnet portion M2 may be provided.

The first weight portion 65 includes a first weight member 651. In the present embodiment, the first weight portion 65 does not have a member other than the first weight member 651. The second weight portion 66 includes a second weight member 661. In the present embodiment, the second weight portion 66 does not have a member other than the second weight member 661.

The first weight portion 65 and the second weight portion 66 are disposed at positions with the first magnet portion M1 and the second magnet portion M2 being interposed therebetween in the lateral direction. The length Lm of the first magnet portion M1 and the second magnet portion M2 in the lateral direction is shorter than an interval Lw between the first weight portion 65 and the second weight portion 66 in the lateral direction. Gaps S1 and S2 are disposed between the first weight portion 65 and the first magnet portion M1 and the second magnet portion M2. Gaps S3 and S4 are disposed between the second weight portion 66 and the first magnet portion M1 and the second magnet portion M2. In addition, the length of the coil member 3 in the lateral direction is shorter than a length of the first magnet portion M1 and the second magnet portion M2 in the lateral direction.

The elastic member 7 and the elastic member 8 are leaf spring members. In brief, the other end portion of the elastic member 7 in the lateral direction is fixed to the holding portion 61, and one end portion in the lateral direction is fixed to the cover 12. In addition, one end portion of the elastic member 8 in the lateral direction is fixed to the holding portion 61, and the other end portion in the lateral direction is fixed to the cover 12. Accordingly, the vibrating body 6 is supported by the elastic members 7 and 8 so as to vibrate in the lateral direction with respect to the casing 1. Details of the configuration of the elastic member 7 will be described below.

Next, an operation of the vibration motor 100 having the configuration described above will be described. The state illustrated in FIG. 2 is a state where the coil member 3 is not energized and the vibrating body 6 is in a stationary state. In this state, the vibrating body 6 can vibrate in the lateral direction by the control of switching the magnetic poles generated in the coil member 3 being performed by the energization control.

While the vibrating body 6 vibrates, in a state where the positions of the S-poles of the first magnets 62A and 62B become positions that are shifted further to one side in the lateral direction from one end of the coil member 3 in the lateral direction, in a case where the N-pole is generated at one end of the coil member 3 in the lateral direction, a force toward the other side in the lateral direction acts on the vibrating body 6 by the attraction between the S-pole of the first magnet 62A and 62B and the N-pole of the coil member 3. Accordingly, the vibrating body 6 moves in a direction in which the first weight portion 65 approaches the damper member 4.

Due to the disposition of the gaps S1 and S2, with the movement of the vibrating body 6, before the first weight portion 65 comes into contact with the damper member 4, the positions of the S-poles of the first magnets 62A and 62B can be located further on the other side in the lateral direction than the position of the N-pole of the coil member 3 at one end in the lateral direction. In this state, due to the attraction between the S-poles of the first magnets 62A and 62B and the N-pole of the coil member 3, a force directed to one side in the lateral direction which is opposite to the direction in which the vibrating body 6 moves, is applied.

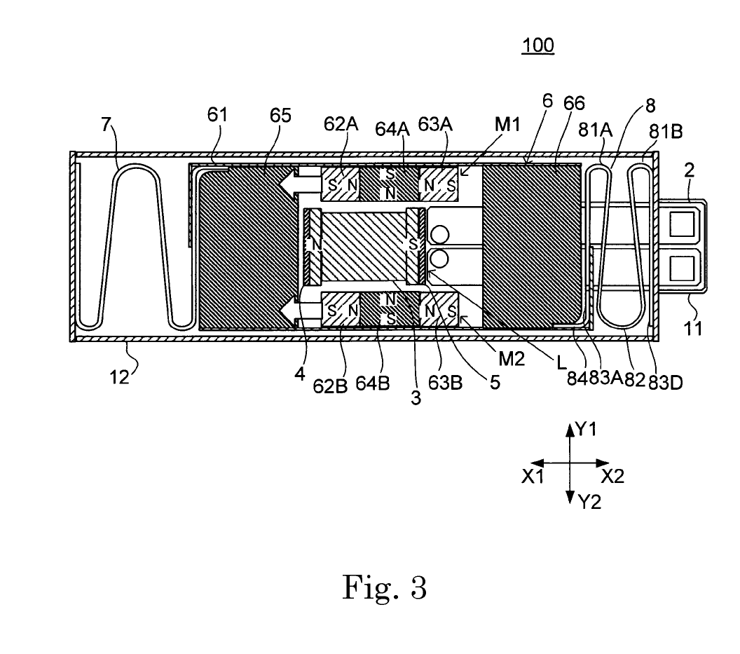

Accordingly, the vibrating body 6 is decelerated, and as illustrated in FIG. 3, the vibrating body 6 can be stopped before the first weight portion 65 comes into contact with the damper member 4. The hollow arrows illustrated in FIG. 3 are forces acting on the vibrating body 6 toward the one side in the lateral direction. In other words, due to the magnetic damper effect, the first weight portion 65 is not in contact with the damper member 4 at the maximum displacement of the vibrating body 6. Accordingly, generation of noise as a collision sound caused by a collision between the first weight portion 65 and the damper member 4 can be suppressed.

In addition, even in a case where the N-pole is generated at the other end of the coil member 3 in the lateral direction, similarly as described above, in the vibrating body 6 which moves to one side in the lateral direction, a force directed toward the other side in the lateral direction opposite to the moving direction acts by attraction between the S-poles of the second magnets 63A and 63B and the N-pole of the coil member 3. Due to such a magnetic damper effect as described above, the vibrating body 6 can be stopped before the second weight portion 66 comes into contact with the damper member 5. Therefore, when the vibrating body 6 is maximally displaced, the second weight portion 66 is not in contact with the damper member 5, and generation of noise due to a collision between the second weight portion 66 and the damper member 5 can be suppressed.

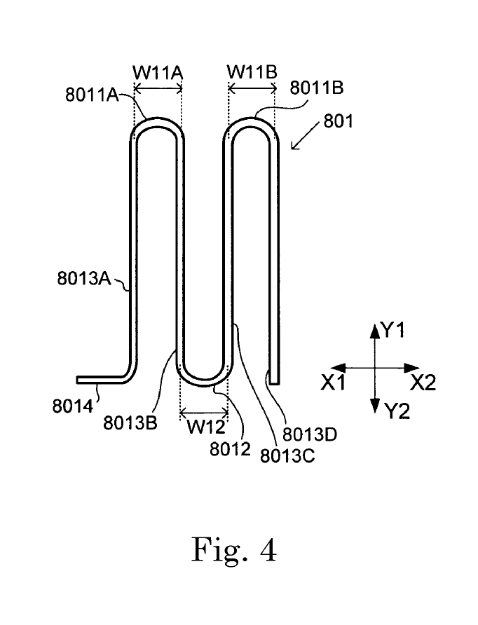

Next, the elastic members 7 and 8 will be described in detail. Here, FIG. 4 is a plan view illustrating an elastic member 801 having a structure similar to that of Chinese Patent Application Publication No. 105518983 described above, for comparison with an elastic member 8 in the vibration motor 100 according to the present embodiment.

As illustrated in FIG. 4, the elastic member 801 which is a leaf spring member has two first bent portions 8011A and 8011B, one second bent portion 8012, flat portions 8013A to 8013D, and a fixed portion 8014. The first bent portions 8011A and 8011B are bent toward one side in the longitudinal direction. The second bent portion 8012 is bent toward the other side in the longitudinal direction. In other words, the second bent portion 8012 is bent toward a side opposite to the first bent portions 8011A and 8011B in the longitudinal direction.

Each of the flat portions 8013A to 8013D has only a portion extending linearly in a plan view and does not have a curved portion. The same applies to the other flat portions described below. The flat portions 8013A to 8013D extend in the longitudinal direction in the natural state of the elastic member 801 when the vibrating body 6 is in a stationary state.

The flat portion 8013A and the flat portion 8013B are connected to respective ends of the first bent portion 8011A. The flat portion 8013B and the flat portion 8013C are connected to respective ends of the second bent portion 8012. The flat portion 8013C and the flat portion 8013D are connected to respective ends of the first bent portion 8011B. The fixed portion 8014 curves from the other end in the longitudinal direction of the flat portion 8013A and extends to one side in the lateral direction.

As illustrated in FIG. 4, in the elastic member 801, the width W11A of the first bent portion 8011A in the lateral direction and the width W11B of the first bent portion 8011B in the lateral direction are the same. The width in the lateral direction is the interval between respective ends of the bent portion in the lateral direction, and the same shall apply hereinafter. In addition, the width W12 of the second bent portion 8012 in the lateral direction is the same as the widths W11A and W11B in the lateral direction. In other words, the widths of all the bent portions in the lateral direction are uniform.

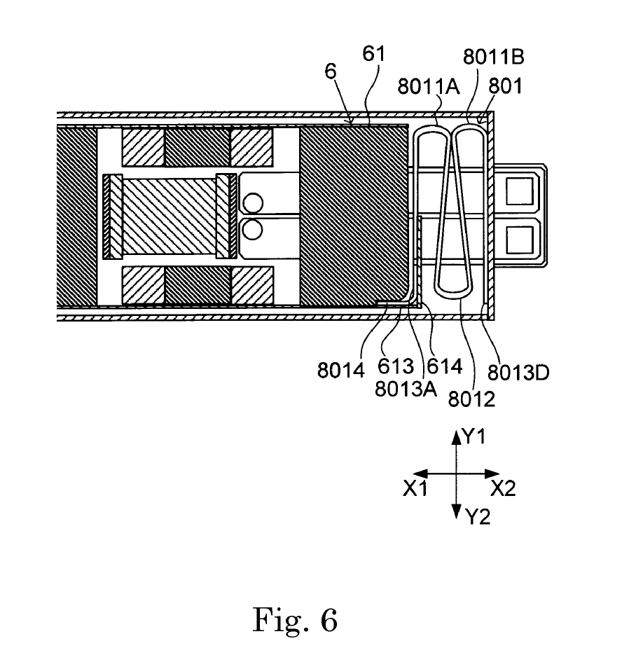

Here, the fixed portion 8014 is fixed to the side plate portion 613, the flat portion 8013A is fixed to the side plate portion 614, and the flat portion 8013D is fixed to the inner surface of the cover 12, and thus the elastic member 801 is fixed between the vibrating body 6 and the cover 12. In this state, as illustrated in FIG. 6, in a case where the elastic member 801 is compressed by the displacement of the vibrating body 6, there is a concern that the first bent portions 8011A and 8011B may collide with each other. In other words, as described above, when the width of each bent portion in the lateral direction is uniform, the first bent portions 8011A and 8011B, which are greater in number than the second bent portion 8012, are likely to collide with each other when the elastic member 801 is compressed. There is a problem that noise as a collision sound is generated due to the collision between the bent portions.

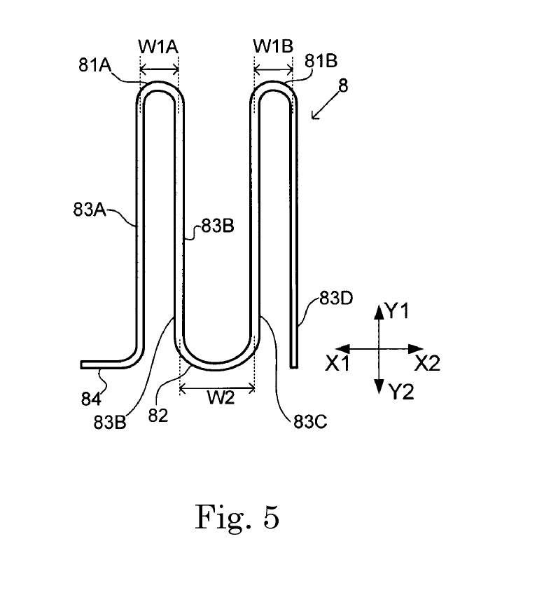

Therefore, in the present embodiment, the configuration of the elastic member 8 is as follows. FIG. 5 is a plan view of the elastic member 8 according to the present embodiment. As illustrated in FIG. 5, the elastic member 8, which is a leaf spring member, has two first bent portions 81A and 81B, one second bent portion 82, flat portions 83A to 83D, and a fixed portion 84. The first bent portions 81A and 81B are bent toward one side in the longitudinal direction. The second bent portion 82 is bent toward the other side in the longitudinal direction. In other words, the second bent portion 82 is bent toward a direction opposite to the first bent portions 81A and 81B in the longitudinal direction. The flat portions 83A to 83D extend in the longitudinal direction in a natural state of the elastic member 8 when the vibrating body 6 is in a stationary state.

The flat portion 83A and the flat portion 83B are connected to respective ends of the first bent portion 81A. The flat portion 83B and the flat portion 83C are connected to respective ends of the second bent portion 82. The flat portion 83C and the flat portion 83D are connected to respective ends of the first bent portion 81B. The first bent portions 81A and 81B and the second bent portion 82 are alternately connected by the flat portions 83B and 83C. The fixed portion 84 is curved from the other end of the flat portion 83A in the longitudinal direction and extends in one side in the lateral direction.

As illustrated in FIG. 5, in the elastic member 8, the width W1A of the first bent portion 81A in the lateral direction and the width W1B of the first bent portion 81B in the lateral direction are the same. In addition, the widths W1A and W1B in the lateral direction are smaller than the width W2 of the second bent portion 82 in the lateral direction. In other words, the widths of the first bent portions 81A and 81B in the lateral direction whose number is greater than that of the second bent portion 82 are made small.

As illustrated in FIG. 2, by fixing the fixed portion 84 to the side plate portion 613, fixing the flat portion 83A to the side plate portion 614, and fixing the flat portion 83D to the inner surface of the cover 12, the elastic member 8 is fixed between the vibrating body 6 and the cover 12. In this state, as illustrated in FIG. 3, in a case where the elastic member 8 is compressed by the displacement of the vibrating body 6, collision between the first bent portions 81A and 81B are suppressed. In other words, with the widths of the respective bent portions in the lateral direction having the size relationship as described above, the collision between the first bent portions 81A and 81B which are greater in number than the second bent portion 82 is suppressed when the elastic member 8 is compressed. Therefore, generation of noise due to collision sound can be suppressed.

In addition, as can be seen from the comparison between FIG. 4 and FIG. 5 described above, the generation of noise can be suppressed by adjusting the width of each bent portion in the lateral direction without changing the width of the entire elastic member in the lateral direction. In other words, the increase in the width of the entire vibration motor in the lateral direction can be suppressed.

In the elastic member 7 having the same configuration as the elastic member 8, in a case where the vibrating body 6 is displaced to one side in the lateral direction and the elastic member 7 is compressed, collision between two bent portions which are bent toward the other side in the longitudinal direction in FIG. 2 is suppressed.

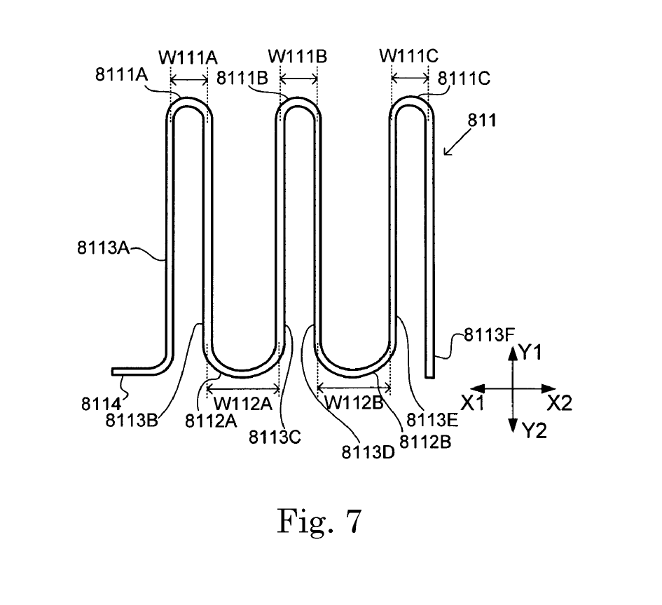

Here, FIG. 7 is a plan view of an elastic member 811 according to a first modification example of the present embodiment. As illustrated in FIG. 7, the elastic member 811 includes first bent portions 8111A to 8111C, second bent portions 8112A and 8112B, flat portions 8113A to 8113F, and a fixed portion 8114. The difference between the configuration of the elastic member 811 and the elastic member 8 is the number of the first bent portions 8111A to 8111C and the number of the second bent portions 8112A and 8112B. In other words, the elastic member 811 has three first bent portions 8111A to 8111C and two second bent portions 8112A and 8112B.

The widths W111A to W111C in the lateral direction of all the first bent portions 8111A to 8111C are the same, and the widths W112A and W112B in the lateral direction of all the second bent portions 8112A and 8112B are the same. The widths W111A to W111C in the lateral direction are smaller than the widths W112A and W112B in the lateral direction.

According to such a configuration, even in a case where the elastic member 811 is compressed by the displacement of the vibrating body 6, collision between adjacent ones among the first bent portions 8111A to 8111C having a large number is suppressed.

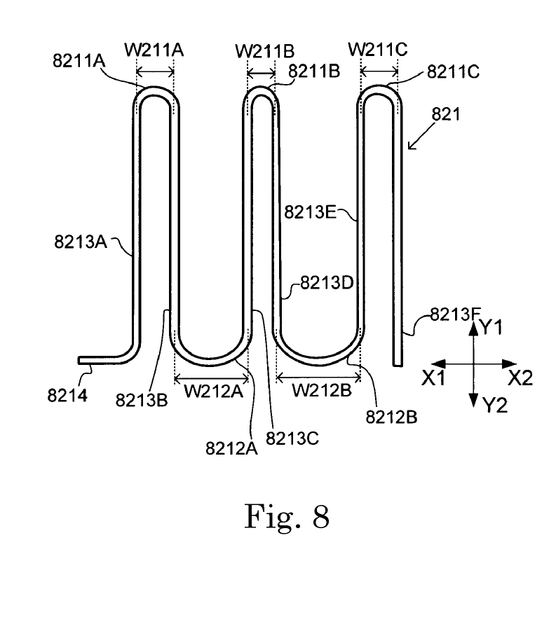

FIG. 8 is a plan view of an elastic member 821 according to a second modification example of the present embodiment. As illustrated in FIG. 8, the elastic member 821 has first bent portions 8211A to 8211C, second bent portions 8212A and 8212B, flat portions 8213A to 8213F, and a fixed portion 8214.

The width W211A of the first bent portion 8211A in the lateral direction and the width W211C of the first bent portion 8211C in the lateral direction are the same and the width W211B of the first bent portion 8211B in the lateral direction is smaller than the widths W211A and W211C in the lateral direction. The width W212A of the second bent portion 8212A in the lateral direction is smaller than the width W212B of the second bent portion 8212B in the lateral direction. The widths W211A and W211C in the lateral direction are smaller than the width W212A in the lateral direction. In other words, the widths W211A and W211C in the lateral direction, which are the maximum width among the first bent portions 8211A to 8211C in the lateral direction, are smaller than the width W212A in the lateral direction which is the minimum width among the second bent portions 8212A and 8212B in the lateral direction.

According to such a configuration, even in a case where the elastic member 821 is compressed by the displacement of the vibrating body 6, collision between adjacent ones of the first bent portions 8211A to 8211C, which are disposed in a large number, is suppressed.

However, the elastic member 821 differs from the elastic member 811 illustrated in FIG. 7 in that the widths of the first bent portions in the lateral direction are not the same and the widths of the second bent portions in the lateral direction are also not the same. Accordingly, in the elastic member 821, the flat portion 8213C and the flat portion 8213D connected to respective end portions of the first bent portion 8211B having a short width in the lateral direction are likely to collide with each other. On the other hand, in a case of the elastic member 811, since the widths of all the first bent portions in the lateral direction are the same and the widths of all the second bent portions in the lateral direction are the same, occurrence of a colliding portion can be suppressed as a whole.

As described above, the vibration motor 100 according to the present embodiment includes a stationary portion S, a vibrating body 6 that is supported to vibrate in the lateral direction with respect to the stationary portion S, and an elastic member 8 that is positioned between the stationary portion S and the vibrating body 6.

The elastic member 8 includes at least two first bent portions 81A and 81B bending in a longitudinal direction orthogonal to the lateral direction, at least one second bent portion 82 bending toward a side opposite to the first bent portions 81A and 81B in the longitudinal direction, and flat portions 83A to 83D connected to respective ends of the first bent portions 81A and 81B and respective ends of the second bent portion 82.

The number of the first bent portions 81A and 81B is greater than the number of the second bent portions 82 and the first bent portions 81A and 81B and the second bent portion 82 are alternately connected by the flat portions 83B and 83C and the maximum width among the widths W1A and W1B of the first bent portions 81A and 81B in the lateral direction is smaller than the minimum width of the width W2 of the second bent portion 82 in the lateral direction.

The feature of the configuration of the elastic member described above also holds true for the elastic members 811 and 821.

According to such a configuration, even in a case where the vibrating body 6 is displaced and the elastic member is compressed, collision between the first bent portions can be suppressed, and generation of noise due to the collision sound can be suppressed. In addition, by suppressing the increase in the overall width of the elastic member in the lateral direction, increase in the overall width of the vibration motor in the lateral direction can be suppressed.

In the structure described above, in particular, in the elastic member 811, the widths of all the first bent portions 8111A to 8111C in the lateral direction are substantially the same and the widths of all the second bent portions 8112A and 8112B in the lateral direction are substantially the same.

According to such a configuration, the occurrence of a collision point can be suppressed in the entire elastic member.

In the configuration described above, the stationary portion S includes a casing 1 and a coil portion L. The vibrating body 6 includes a first weight portion 65, a second weight portion 66, and magnet portions M1 and M2. The first weight portion 65 and the second weight portion 66 are disposed at positions with the magnet portions M1 and M2 being interposed therebetween from both sides in the lateral direction.

The magnet portions M1 and M2 respectively include first magnets 62A and 62B and second magnets 63A and 63B having magnetic flux directions opposite to each other in the lateral direction, and third magnets 64A and 64B interposed between the first magnets 62A and 62B and the second magnets 63A and 63B from both sides in the lateral direction and having a magnetic flux direction in a longitudinal direction orthogonal to the lateral direction. The magnet portions M1 and M2 and the coil portion L are disposed to face each other in the longitudinal direction. The coil member 3 included in the coil portion L generates magnetic flux in the lateral direction. The length of the coil member 3 in the lateral direction is shorter than the length of the magnet portions M1 and M2 in the lateral direction.

According to such a configuration, in a configuration in which a large force is applied to the vibrating body 6 by concentrating the magnetic flux on the coil portion L by the magnet portions M1 and M2 having the so-called Halbach array structure, the elastic member 8 formed with a bent portion and a flat portion is suitable for supporting the vibrating body 6. The generation of noise by such an elastic member 8 can be suppressed.

In the structure described above, the length of the magnet portions M1 and M2 in the lateral direction is shorter than the interval between the first weight portion 65 and the second weight portion 66 in the lateral direction, and a gap is disposed between the first weight portion 65 and the first magnets 62A and 62B, and a gap is disposed between the second weight portion 66 and the second magnets 63A and 63B.

According to such a configuration, since a force pulling back the vibrating body 6 in a direction opposite to a direction in which the vibrating body 6 has been displaced acts on the magnet portions M1 and M2 (magnetic damper effect), and the generation of noise by collision between the first weight portion 65 or the second weight portion 66 and the coil portion L is suppressed.

In the structure described above, the first weight portion 65 and the second weight portion 66 respectively include weight members 651 and 661, and the first weight portion 65 and the second weight portion 66 do not have members at a position between the weight members 651 and 661 and the magnet portions M1 and M2, respectively.

Accordingly, the movable ranges of the first weight portion 65 and the second weight portion 66 are expanded, and the collision between the first weight portion 65 or the second weight portion 66 and the coil portion L can be further suppressed.

In the structure described above, the coil portion L includes the damper members 4 and 5 disposed further outside in the lateral direction than both the end portions of the coil member 3 in the lateral direction.

Accordingly, even in a case where the first weight portion 65 or the second weight portion 66 excessively moves in a case of dropping the vibration motor or the like, the weight portion is in contact with the damper members 4 and 5, and thus excessive deformation of the elastic member can be suppressed. During normal operation, collision between the weight portions 65 and 66 and the damper members 4 and 5 is suppressed by the magnetic damper effect as described above.

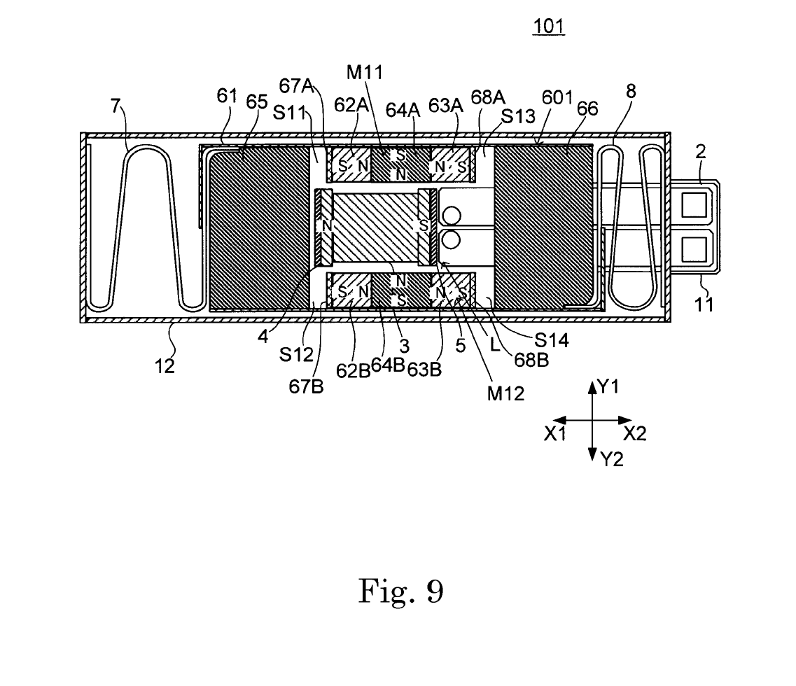

Next, a second embodiment of the present invention as a modification example of the first embodiment will be described. FIG. 9 is a plan sectional view illustrating a configuration of a vibration motor 101 according to the second embodiment. FIG. 9 is a view corresponding to FIG. 2 of the first embodiment.

Here, the differences from the first embodiment will be mainly described. The vibration motor 101 has a vibrating body 601. The vibrating body 601 includes a first magnet portion M11, a second magnet portion M12, a first weight portion 65, and a second weight portion 66.

The first magnet portion M11 includes a first magnet 62A, a second magnet 63A, a third magnet 64A, a back yoke 67A, and a back yoke 68A. Although the first magnet 62A, the second magnet 63A, and the third magnet 64A are similar to those in the first embodiment, the back yoke 67A is fixed to one end of the first magnet 62A in the lateral direction, and the back yoke 68A is fixed to the other end of the second magnet 63A in the lateral direction. The back yokes 67A and 68A have a magnetic body.

The length of the first magnet portion M11 in the lateral direction is shorter than an interval between the first weight portion 65 and the second weight portion 66. A gap S11 is disposed between the back yoke 67A and the first weight portion 65, and a gap S13 is disposed between the back yoke 68A and the second weight portion 66.

The second magnet portion M12 includes a first magnet 62B, a second magnet 63B, a third magnet 64B, a back yoke 67B, and a back yoke 68B. Although the first magnet 62B, the second magnet 63B, and the third magnet 64B have the same configuration as in the first embodiment, the back yoke 67B is fixed to one end of the first magnet 62B in the lateral direction, and the back yoke 68B is fixed to the other end of the second magnet 63B in the lateral direction. The back yokes 67B and 68B have a magnetic body.

The length of the second magnet portion M12 in the lateral direction is shorter than an interval between the first weight portion 65 and the second weight portion 66. A gap S12 is disposed between the back yoke 67B and the first weight portion 65, and a gap S14 is disposed between the back yoke 68B and the second weight portion 66.

In the vibration motor 101 described above, for example, in a case where an N-pole is generated on one side of the coil member 3 in the lateral direction, the vibrating body 601 moves to the other side in the lateral direction. At this time, by disposition of the gaps S11 and S12, before the first weight portion 65 comes into contact with the damper member 4, the back yokes 67A and 67B can be positioned at the position shifted further to the other side in the lateral direction than the position of the N-pole in one end of the coil member 3 in the lateral direction. Accordingly, due to the attraction between the N-pole of the coil member 3 and the back yokes 67A and 67B, a force directed to one side in the lateral direction opposite to the moving direction acts on the vibrating body 601. Therefore, the vibrating body 601 is decelerated by the magnetic damper effect, and the vibrating body 601 can be stopped before the first weight portion 65 comes into contact with the damper member 4. In other words, as illustrated in FIG. 9, contact between the first weight portion 65 and the damper member 4 at the maximum displacement of the vibrating body 601 can be avoided and generation of noise due to a collision can be suppressed.

In addition, even in a case where N-pole is generated on the other side of the coil member 3 in the lateral direction, when the vibrating body 601 moves to one side in the lateral direction, due to the attraction between the N-pole of the coil member 3 and the back yokes 68A and 68B, a force pulling back the vibrating body 601 to the other side in the lateral direction acts on the vibrating body 601. Accordingly, the vibrating body 601 can be stopped before the second weight portion 66 comes into contact with the damper member 5. In other words, contact between the second weight portion 66 and the damper member 5 can be avoided at the maximum displacement of the vibrating body 601 and generation of noise due to a collision can be suppressed.

As described above, in the vibration motor 101 according to the present embodiment, the magnet portions M11 and M12 further include the back yokes 67A, 67B, 68A, and 68B disposed on the outside of the first magnets 62A, 62B and the second magnets 63A and 63B in the lateral direction, respectively.

Accordingly, a larger force for pulling back the vibrating body 601 in a direction opposite to the movement direction can be applied to the vibrating body 601. Therefore, collision between the first weight portion 65 and the second weight portion 66 and the coil portion L can be effectively suppressed.

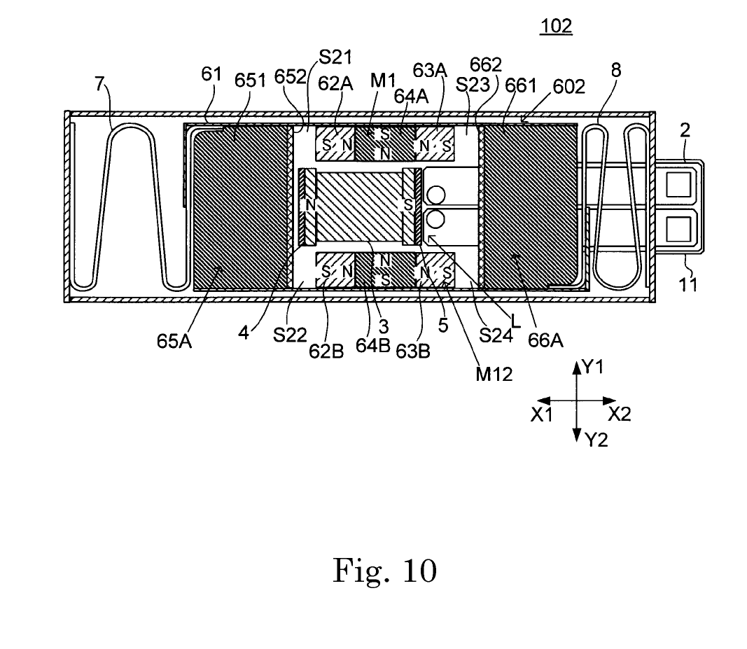

Next, a third embodiment which is another modification example of the first embodiment will be described. FIG. 10 is a plan sectional view illustrating a configuration of a vibration motor 102 according to the third embodiment. FIG. 10 is a view corresponding to FIG. 2 of the first embodiment.

Here, the differences from the first embodiment will be mainly described. The vibration motor 102 has a vibrating body 602. The vibrating body 602 includes a first magnet portion M11, a second magnet portion M12, a first weight portion 65A, and a second weight portion 66A.

In the present embodiment, the first weight portion 65A includes a back yoke 652 in addition to the first weight member 651. The back yoke 652 has a magnetic body and is fixed to the other end of the first weight member 651 in the lateral direction. Further, the second weight portion 66A includes a back yoke 662 in addition to the second weight member 661. The back yoke 662 has a magnetic body and is fixed to one end of the second weight member 661 in the lateral direction.

The length of the first magnet portion M1 in the lateral direction is shorter than the interval between the first weight portion 65A and the second weight portion 66A. Gaps S21 and S22 are disposed between the back yoke 652 and the first magnets 62A and 62B, and gaps S23 and S24 are disposed between the back yoke 662 and the second magnets 63A and 63B.

In the vibration motor 102 having such a configuration, for example, in a case where an N-pole is generated on one side of the coil member 3 in the lateral direction, the vibrating body 602 moves to the other side in the lateral direction. At this time, due to the disposition of the gaps S21 and S22, before the back yoke 652 comes into contact with the damper member 4, the first magnets 62A and 62B can be positioned at a position shifted further to the other side in the lateral direction than the position of the N-pole on the one end of the coil member 3 in the lateral direction. Accordingly, due to the attraction between the N-pole of the coil member 3 and the first magnets 62A and 62B, the vibrating body 602 is applied with a force directed to one side in the lateral direction which is opposite to the moving direction. Therefore, the vibrating body 602 is decelerated by the magnetic damper effect, and the vibrating body 602 can be stopped before the back yoke 652 comes into contact with the damper member 4. In other words, as illustrated in FIG. 10, contact between the back yoke 652 and the damper member 4 can be avoided at the maximum displacement of the vibrating body 602, and generation of noise due to a collision can be suppressed.

In addition, even in a case where the N-pole is generated on the other side of the coil member 3 in the lateral direction, when the vibrating body 602 moves to one side in the lateral direction, by attraction between the N-pole of the coil member 3 and the second magnets 63A and 63B, a force pulling back the vibrating body 602 to the other side in the lateral direction acts. Accordingly, the vibrating body 602 can be stopped before the back yoke 662 comes into contact with the damper member 5. In other words, it is possible to prevent the back yoke 662 and the damper member 5 from contacting each other when the vibrating body 602 is maximally displaced, and generation of noise due to a collision can be suppressed.

As described above, in the vibration motor 102 of the present embodiment, the first weight portion 65A and the second weight portion 66A respectively have the weight members 651 and 661 and back yokes 652 and 662 disposed further on the side of the magnet portions M1 and M2 than the weight members 651 and 661.

Accordingly, the force pulling the first weight portion 65A or the second weight portion 66A toward the coil portion L can increase. In addition, the collision between the first weight portion 65A and the second weight portion 66A and the coil portion L can be effectively suppressed with the magnetic damper effect.

Although the embodiments of the present invention are described above, various modifications can be made to the embodiments as long as the modifications are within the scope of the gist of the present invention.

For example, in the coil portion L, the damper members 4 and 5 are not indispensable members.

The present invention can be applied to a vibration motor provided in, a smartphone, a gamepad, or the like, for example.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a stationary portion;
a vibrating body that is supported to vibrate in a lateral direction with respect to the stationary portion; and
an elastic member that is positioned between the stationary portion and the vibrating body, wherein
the elastic member includes
two or more first bent portions that are bent in a longitudinal direction orthogonal to the lateral direction,
one or more second bent portions that are bent toward a side opposite to the first bent portion in the longitudinal direction, and
flat portions that are connected to respective ends of the first bent portions and respective ends of the second bent portions,
the number of first bent portions is greater than the number of second bent portions,
the first bent portions and the second bent portions are alternately connected by the flat portions, and
a maximum width of the first bent portions in the lateral direction is smaller than a minimum width of the second bent portions in the lateral direction.

2. The vibration motor according to claim 1, wherein
all the widths of the first bent portions in the lateral direction are substantially the same, and
all the widths of the second bent portions in the lateral direction are substantially the same.

3. The vibration motor according to claim 1, wherein
the stationary portion has a casing and a coil portion,
the vibrating body has a first weight portion, a second weight portion, and a magnet portion,
the first weight portion and the second weight portion are disposed at positions with the magnet portion being interposed between the first weight portion and the second weight portion in the lateral direction,
the magnet portion has a first magnet having a magnetic flux direction in the lateral direction, a second magnet having a magnetic flux direction opposite to the magnetic flux direction of the first magnet in the lateral direction, and a third magnet which is interposed between the first magnet and the second magnet in the lateral direction and which has a magnetic flux direction in a longitudinal direction orthogonal to the lateral direction,
the magnet portion and the coil portion are disposed to face each other in the longitudinal direction,
a coil member included in the coil portion generates magnetic flux in the lateral direction, and
a length of the coil member in the lateral direction is shorter than a length of the magnet portion in the lateral direction.

4. The vibration motor according to claim 3, wherein
the length of the magnet portion in the lateral direction is shorter than an interval between the first weight portion and the second weight portion in the lateral direction,
a gap is disposed between the first weight portion and the first magnet, and
a gap is disposed between the second weight portion and the second magnet.

5. The vibration motor according to claim 4, wherein
each of the first weight portion and the second weight portion includes a weight member, and
each of the first weight portion and the second weight portion does not have a member at a position between the weight member and the magnet portion.

6. The vibration motor according to claim 4, wherein
the magnet portion further has a back yoke that is disposed outside of the first magnet and outside of the second magnet in the lateral direction.

7. The vibration motor according to claim 4, wherein
each of the first weight portion and the second weight portion includes a weight member and a back yoke disposed at a position between the weight member and the magnet portion.

8. The vibration motor according to claim 4, wherein
the coil portion has a damper member that is disposed further outside in the lateral direction than both end portions of the coil member in the lateral direction.

9. The vibration motor according to claim 6, wherein
the coil portion has a damper member that is disposed further outside in the lateral direction than both end portions of the coil member in the lateral direction.

10. The vibration motor according to claim 7, wherein
the coil portion has a damper member that is disposed further outside in the lateral direction than both end portions of the coil member in the lateral direction.
